(19) United States
(12) Patent Application Publication
(10) Pub. No.: US 2019/0366333 A1
(43) Pub. Date: Dec. 5, 2019

(54) ELECTRO-WETTING-BASED MICROFLUIDIC DROPLET POSITIONING SYSTEM AND METHOD

(71) Applicants: South China Normal University, Panyu District, GUANGZHOU (CN); Shenzhen Guohua Optoelectronics Co., Ltd., SHENZHEN (CN); Academy of Shenzhen Guohua Optoelectronics, Shenzhen (CN)

(72) Inventors: Guofu ZHOU, GUANGZHOU, GUANGDONG (CN); Zhijie LUO, GUANGZHOU, GUANGDONG (CN); Shuting XIE, GUANGZHOU, GUANGDONG (CN); Weijie LIN, GUANGZHOU, GUANGDONG (CN)

(21) Appl. No.: 16/478,524

(22) PCT Filed: Nov. 15, 2017
(86) PCT No.: PCT/CN2017/110987

§ 371 Date: Jul. 17, 2019

(30) Foreign Application Priority Data
Feb. 24, 2017 (CN) 201710105878.5

(51) Int. Cl. B01L 3/00; G05B 19/402

(52) U.S. Cl. CPC B01L 3/50273; G05B 19/402; G05B 2219/34215; B01L 2200/027; B01L 2200/025; B01L 2200/061; B01L 2400/0427

(57) ABSTRACT

An electro-wetting-based microfluidic droplet positioning system, includes an electro-wetter, a microprocessor, a main control module, a droplet drive module, a droplet positioning module and a power supply. Further, an electrowetting-based microfluidic droplet positioning method, includes the steps of: considering, by a system, a droplet to be measured in an electro-wetter and a hydrophobic insulation layer below the droplet as a capacitor connected in series; issuing, by a main control chip, a command to a droplet drive module, and driving, by the droplet drive module, the droplet to be measured to move; collecting, by a droplet positioning module, a current capacitance value of the droplet, and determining a relative position of the droplet; and verifying, by the system, whether the droplet is at a target position.

### FIELD

The disclosure relates to a field of digital microfluidic technology, and in particularly, to an electro-wetting-based microfluidic droplet positioning system and method.

### BACKGROUND

A dielectric wetting microfluidic technology is a method for using an electric field to control the surface tension of liquid, which can change the wettability of a droplet and a solid surface by controlling an applied voltage to cause an internal pressure difference inside the droplet and then drive the microdroplet to move.

Droplet microfluidic, also known as digital microfluidic, is a research hotspot of microfluidic technology due to the advantages of less sample consumption, fast reaction, good mass and heat transfer effect and no cross contamination. A typical microfluidic chip mainly operates on continuous fluid. Functional components such as a microchannel, a micropump, a microvalve, a microreservoir, a microelectrode, a detecting element, a window and a connector are integrated into a micro total analysis system on a chip material like an integrated circuit through a microfabrication technology. In recent 10 years, a dielectricwetting-based digital microfluidic chip has become the research focus of many microfluidic research institutions, and great progress has been made. At, the volume of the operable and controllable droplet has reached microliter or even nanoliter, so that different types of droplets can be driven and controlled on a micro scale.

For the experiment of the dielectric-wetting-based digital microfluidic chip, to determine the current position of the droplet and the real-time status of the chip is of great concern. Most of the existing researches on the dielectric-wetting microfluidic in the prior art focus on the drive mechanism of the droplet and electrode design, but few researches on the positioning and feedback of the related droplet are provided. In 2004, H. Ren et al. used an annular oscillating circuit to distribute and position the highly-accurate droplet. Then, Gong et al. proposed an integrated droplet positioning and feedback system based on an improved annular oscillating circuit, which fed back the distribution status of the droplet to a droplet generator in real time. Shin et al. invented a control system based on visual feedback. The controller could lock the position of the droplet by detecting the relative position of a cross section of the droplet and a drive electrode. But this system needs a high-precision video processing system, so that the expense and cost are higher. In 2011, Shih et al. invented a sensor-based feedback control system. The sensor is used for detecting an alternating current signal of a EWOD chip, and comparing with a drive voltage signal applied to achieve the purpose of feedback and control. However, this technology is more dependent on the characteristics of the droplet and has poor universality.

In conclusion, it is necessary to improve the technology.

### SUMMARY

In order to solve the above technical problem, the disclosure aims at providing an electro-wetting-based microfluidic droplet positioning system and method, which can be used for, specific to a “chip-droplet” equivalent capacitance model of the current movement status and movement position of a droplet, intuitively realizing the current movement status and position of the droplet from such parameter of a capacitance value according to the model, and thus driving the droplet to move.

The technical solutions in the disclosure are as follows.

The disclosure provides an electro-wetting-based microfluidic droplet positioning system, including an electro-wetter, a microprocessor, a main control module, a droplet drive module, a droplet positioning module and a power supply. The microprocessor is connected with the main control module. An output end of the main control module is connected with an input end of the droplet drive module. An output end of the droplet drive module is connected with an input end of the electro-wetter. An output end of the electro-wetter is connected with an input end of the droplet positioning module. An output end of the droplet positioning module is connected with an input end of the main control module. An output end of the power supply is connected with the input end of the main control module.

In an improvement of the technical solution, the main control module is a STM32 chip.

In an improvement of the technical solution, the droplet drive module is an SSD1627 chip.

In an improvement of the technical solution, the droplet positioning module includes a data collecting chip and a data processing chip.

Further, the data collecting chip is a Pcap01 chip.

Further, the data processing chip is a CycloneIV chip.

On the other hand, the disclosure further provides an electro-wetting-based microfluidic droplet positioning method, including the following steps of:

considering, by a system, a droplet to be measured in an electro-wetter and a hydrophobic insulation layer below the droplet as a capacitor connected in series;

issuing, by a main control chip, a command to a droplet drive module, and driving, by the droplet drive module, the droplet to be measured to move;

collecting, by a droplet positioning module, a current capacitance value of the droplet, and determining a relative position of the droplet;

and verifying, by the system, whether the droplet is at a target position; if the droplet is not at the target position, issuing, by the main control module, a command to the droplet drive module and driving the droplet to move until the droplet reaches the target position; and if the droplet is at the target position, issuing, by the main control module, a command to the droplet drive module and driving the droplet to move to next target position.

The disclosure has the advantageous effects as follows: in the disclosure, a solution of a droplet positioning and feedback system based on a system “chip-droplet” equivalent capacitance model is proposed, a “chip-droplet” equivalent capacitance model is established, a droplet driving system is combined with a droplet positioning system, and then a real-time status of the droplet and the hydrophobic layer inside the current chip is fed back to the driving system. In this way, the specific position and general distribution of the droplet on the EWOD chip electrode can be more accurately realized with the data support rather than being only observed by naked eyes. The highly intelligent and accurate droplet movement positioning and feedback system and method can be used to position and control more intuitively and directly, which are convenient and more effective, are beneficial for improving the movement continuity and movement speed of the droplet, and have practicability and certain innovation.

### BRIEF DESCRIPTION OF THE DRAWINGS

The specific embodiments of the disclosure will be described in detailed with reference to the drawings wherein:

FIG. 1 is a system control schematic diagram in an embodiment of the disclosure;

FIG. 2 is a control flow diagram in an embodiment of the disclosure;

FIG. 3 is a structural diagram of an electro-wetting-based bipolar plate microfluidic chip in an embodiment of the disclosure

FIG. 4 is a schematic diagram of an equivalent circuit of a “chip-droplet” system in an embodiment of the disclosure;

FIG. 5 is a diagram of the equivalent circuit in an embodiment of the disclosure;

FIG. 6 is a top view of droplet distribution in an embodiment of the disclosure; and

FIG. 7 is a diagram of experimental data in an embodiment of the disclosure.

### DETAILED DESCRIPTION

It should be noted that, without conflict, the embodiments in the application can be combined with the features in the embodiments mutually.

Equivalent capacitance is an essential circuit property of the EWOD chip. In one EWOD chip with fixed parameters, the capacitance value of each drive electrode unit is only related to the relative position of the drive electrode. In this solution, a dimensionless value is obtained by collecting the equivalent capacitance ration on the drive electrode adjacent to the EWOD chip by means of such characteristics. According to the dimensionless value, the distribution and position of the droplet of the droplet on the two drive electrodes can be analyzed and positioned. Therefore, the capacitance value thereof can be detected to reflect whether a bad point is formed to judge the type of the bad point and an opening rate of the bad point. The capacitance value is measured by a capacitance measuring platform based on Pcap01-AD controlled by FPGA.

In this solution a droplet positioning and feedback system based on a system equivalent capacitance model is proposed. The model and system can accurately detect the current position of the droplet in the EWOD chip and the current distribution on the drive electrode, and simultaneously transmit this information to the driving system in real time. Then, the driving system recharges the determined drive electrode according to the current status. The integrated model and system can improve the continuity and movement speed of droplet movement and play an important auxiliary role in the application of a digital microfluidic chip.

The electronic circuit model is an effective method for analyzing and predicting the behavior of a EWOD system. According to the principle of dielectric wetting, the capacitive character is the essential circuit property of the EWOD chip. Therefore, the designed bipolar plate microfliodic chip can be regarded as an equivalent capacitance system. As shown in FIG. 4, for a minimum drive unit, the equivalent circuit of the EWOD chip mainly consists of three parallel circuit systems. First of all, the dielectric layer and the hydrophobic layer (thicker Teflon is designed and used as the hydrophobic dielectric layer for the chip of this solution) on a lower power plate form one equivalent capacitance; secondly, an aqueous layer on an upper pole plate and that on the lower pole plate directly contacting the droplet also can form one equivalent capacitance, but the later equivalent capacitance value is greater than the previous equivalent capacitance. Therefore, for one serial equivalent capacitance system, a voltage drop of the equivalent capacitance formed by the hydrophobic layer between the upper pole plates can be ignored, but most of the voltage drop occurs in the equivalent capacitance of the lower pole plate. Therefore, the droplet is a grounding end of the equivalent capacitance of the system in the circuit system of the EWOD chip. Meanwhile, media surrounding the droplet forms a capacitor. For the largest number of microfluidic droplets, the electrical conductivity of the droplet is several orders of magnitude greater than that of the solid dielectric layer and the surrounding dielectric fluid. The resistivity of the later can be considered towards infinity. So it is through that the parts containing the droplet form a capacitor and a resistor which are parallel to each other. It is mentioned here that a spherical liquid surface with a certain amount of radian is formed on the left and right surfaces of the droplet. This spherical liquid surface will change the electric field between the drive electrodes. But compared with the change of electric field caused by the distance between the drive electrode and the plate, the change of electric field in the spherical liquid surface is smaller and can be ignored. Therefore, for the single drive electrode of the EWOD chip, its circuit equivalent capacitance can be expressed as:

$${C}_{1} = \frac{{C}_{3} {C}_{2}}{{C}_{3} + {C}_{2}}$$

where, C₁ represents the capacitance of the equivalent model, C₂ represents the capacitance of the droplet, and C₃ represents the capacitance of the hydrophobic insulation layer.

FIG. 5 is a simplified schematic diagram of an equivalent circuit of a “chip-droplet” system. The capacitance of the droplet is negligible when using a direct current voltage (DC) to drive the drive electrode of one EWOD chip. The formula can be simplified as below:

C₁=C₃.

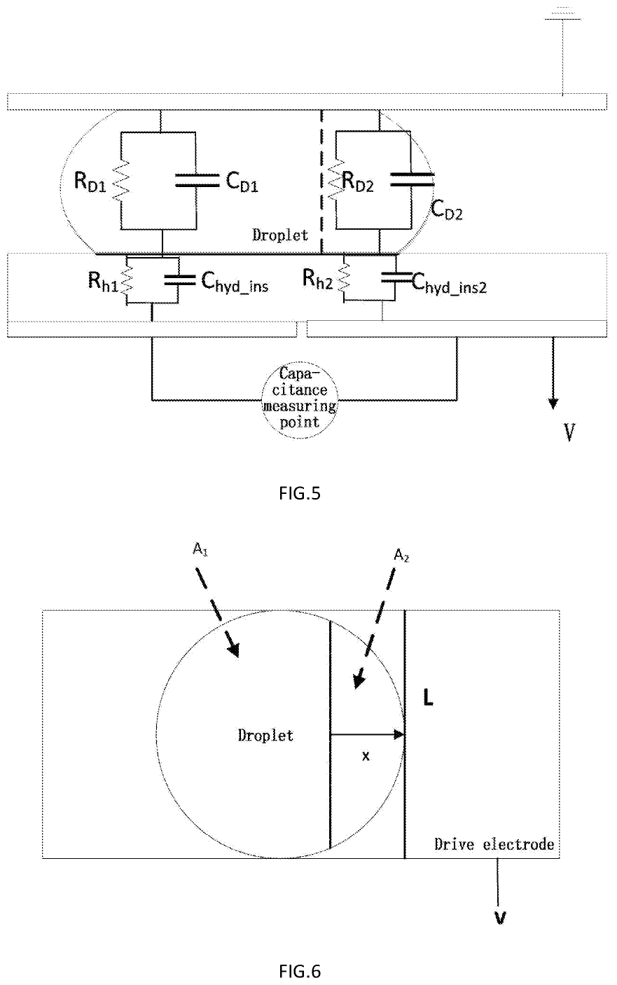

According to a theoretical mode, for a microdroplet with a radius of R, an area of the droplet in the process of motion can be divided into three parts to describe and calculate, as shown in FIG. 6. The area of the three droplets can be calculated by the following formula:

$${S}_{1} = π {r}^{2} - {S}_{2} ;$$

$${S}_{2} = \frac{{r}^{2}}{cos ( 1 - \frac{x}{y} )} - ( r - x ) \sqrt{{r}^{2} - {( x - r )}^{2}} ;$$

$${S}_{3} = π {r}^{2} .$$

The above formula has several-power and trigonometric functions, a large number of arithmetic operations will be produced in practical applications, so that the droplet takes the shape of a rectangle simply, that is, the areas can be simplied into the following formulas:

S₁=(r−x)L

S₂=Lx

S₃=Lr

According to the area obtained by the above formula, the system equivalent capacitance corresponding to the three parts can be further calculated by using the formula of the parallel plate capacitance, as shown in the formulas below:

$${C}_{2}^{′} = \frac{{S}_{2} {ɛ}_{0} {ɛ}_{AF}}{{d}_{AF}}$$

$${C}_{1}^{′} = \frac{{S}_{1} {ɛ}_{0} {ɛ}_{AF}}{{d}_{AF}}$$

$${C}_{3}^{′} = \frac{{S}_{3} {ɛ}_{0} {ɛ}_{AF}}{{d}_{AF}}$$

where ε₀ represents a dielectric constant of the vacuum, and E represents s a dielectric constant of the hydrophobic insulation layer. One equation for solving x can be solved by using the capacitance ratio of the two drive electrodes. In this solution, a unilateral measurement method based on the system equivalent capacitance model is adopted. The method is designed as shown in the schematic diagram, which obtains one equation for solving x by measuring the total equivalent capacitance of the two adjacent electrodes, and finally determines the current position of the droplet.

According to the formula, the following equation can be solved.

x²Lε₀ε_{AF}−xrLε₀ε_{AF}+C₁rd_{AF}=0

where C₁ represents the total equivalent capacitance of the two adjacent electrodes in the current status. The specific position and general distribution of the droplets on the electrode of the EWOD chip at the current moment can be obtained by measuring this equivalent capacitance value.

The unilateral measurement method has the following advantages of: 1. reducing a lead of the drive electrode on a PCB, thus increasing a wiring space of the PCB; and 2. reducing the expense of the device and improving the real-time performance of system driving and positioning without the isolation of a photoelectric relay.

The solutions are specifically implemented below:

A. Setting Up a Measuring System

FIG. 1 is a system architecture diagram of an embodiment according to the disclosure. An electro-wetting-based microfluidic droplet positioning system includes an electro-wetter, a microprocessor, a main control module, a droplet drive module, a droplet positioning module and a power supply, wherein the microprocessor is connected with the main control module, an output end of the main control module is connected with an input end of the droplet drive module, an output end of the droplet drive module is connected with an input end of the electro-wetter, an output end of the electro-wetter is connected with an input end of the droplet positioning module, an output end of the droplet positioning module is connected with an input end of the main control module, and an output end of the power supply is connected with the input end of the main control module.

The system includes a STM32 chip and a SSD1627 chip of a STEM chip made in ARM Company, wherein the STM32 chip is regarded as the main control chip, and the SSD1627 chip is regarded as the drive chip of the EWOD chip. Both of the chips are communicated by I²C. The droplet positioning includes a Pcap01 chip made in German ACAM Company and a CycloneIV chip of a FPGA chip made in ALTERA Company, wherein the Pcap01 chip is regarded as a collector for “chip-droplet” equivalent capacitance, and the CycloneIV chip is used for data processing of a capacitance value collected from the Pcap01 chip to determine a relative position of the droplet on the EWOD chip. Both of the chips are communicated by SPI. And then, the data processed (i.e. the relative position of the droplet on the EWOD chip) is fed back to the main control chip STM by the CycloneIV chip.

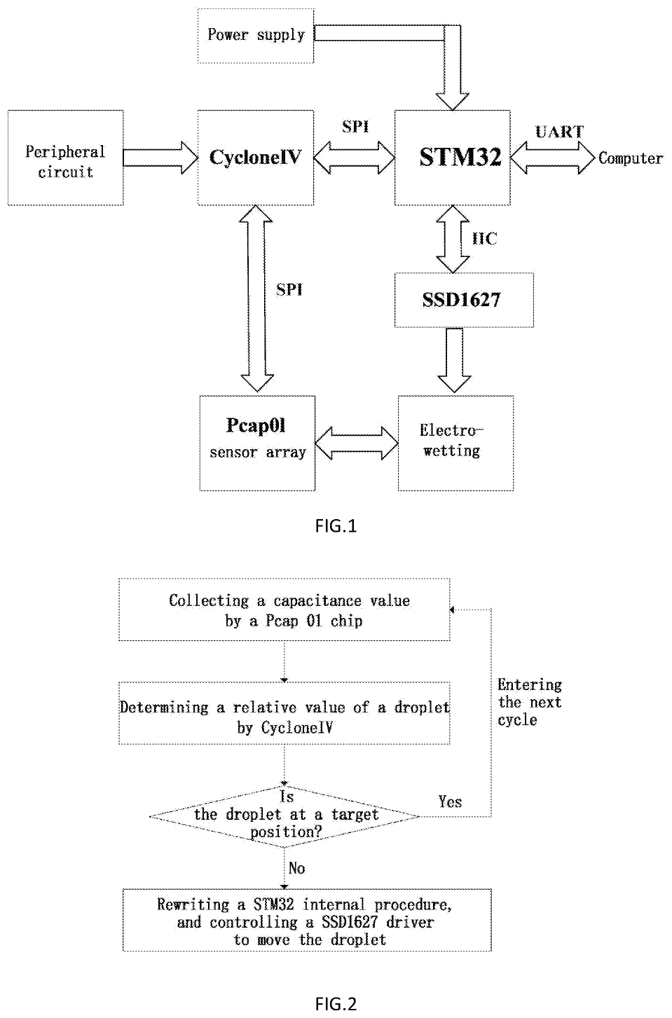

FIG. 2 is a control flow diagram of an embodiment of the disclosure. An electro-wetting-based microfluidic droplet positioning method includes the following steps of:

considering, by a system, a droplet to be measured in an electro-wetter and a hydrophobic insulation layer below the droplet as a capacitor connected in series;

issuing, by a main control chip, a command to a droplet drive module, and driving, by the droplet drive module, the droplet to be measured to move;

collecting, by a droplet positioning module, a current capacitance value of the droplet, and determining a relative position of the droplet;

and verifying, by the system, whether the droplet is at a target position; if the droplet is not at the target position, issuing, by the main control module, a command to the droplet drive module and driving the droplet to move until the droplet reaches the target position; and if the droplet is at the target position, issuing, by the main control module, a command to the droplet drive module and driving the droplet to move to next target position.

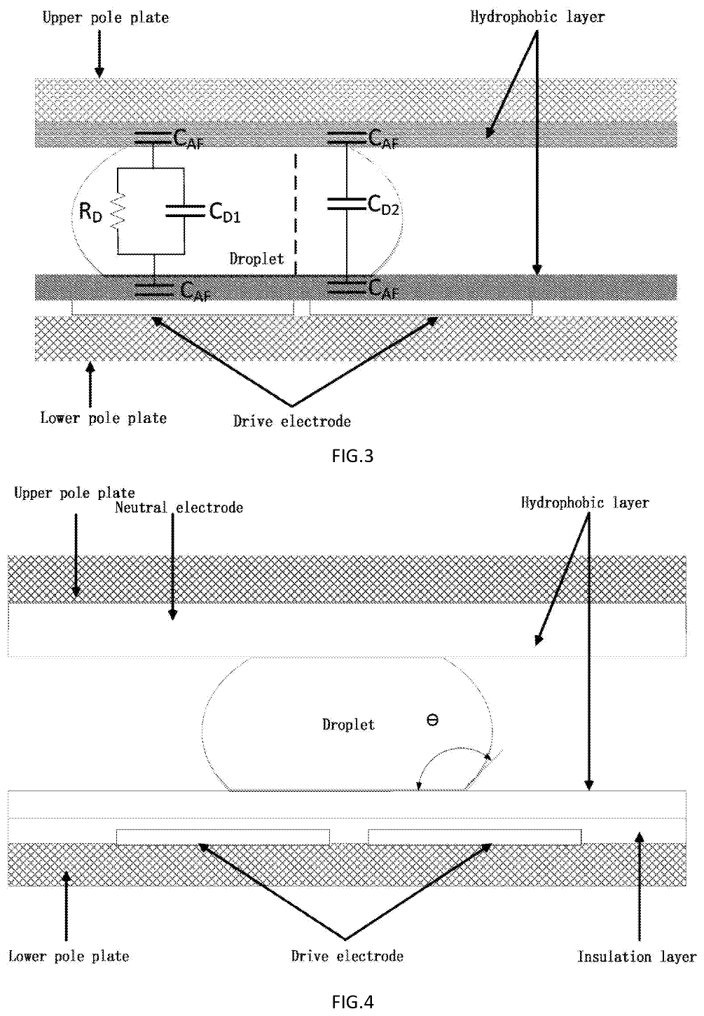

According to FIG. 3 to FIG. 5, as one embodiment, it provides a configuration solution that: electrodes are marked as the electrode 1, the electrode 2 and the electrode 3 respectively, the drive voltage is 30V; the droplet completely covers the electrode 1, and occupies 0.5 mm (wherein a diameter r of the spherical droplet is equal to 4 mm, and a width L of the electrode is equal to 3 mm) in the electrode 2, and the capacitance is measured in a clock trigger mode. The experimental purpose is to totally move the droplet from the electrode 1 to the electrode 3. A command is issued by the main control chip STM32 through I²C, so that a 30V voltage is applied to the electrode 2 to drive the droplet to move on the electrode 3 of the EWOW chip. Then, according to this configuration, the data of the three drive electrode can be collected by each sensor on a sensor array based on the Pcap01 chip in the meanwhile, a capacitance value between the electrode 1 and the electrode 2 and that between the electrode 2 and the electrode 3 can be collected by the Pcap01 chip. The position of the droplet thereof on the electrode 2 can be known by experimental data in table 1 below, that is, the equivalent capacitance value thereof is the maximum when a numerical value of the droplet on the electrode 2 is 2 mm. Only 10 Pcap01 chip are needed for a complex EWOD chip (generally having 30 drive electrode units). During measurement, measuring pins of the Pcap01 chip are connected with pins of the electrode 1, the electrode 2 and the electrode 3 respectively.

B. Measuring a Capacitance Value of Each Electrode on the EWOD Chip

FIG. 4 is a schematic diagram of an equivalent circuit of a “chip-droplet” system. The current position of the droplet is determined by the formula, x²Lε₀ε_{AF}−xrLε₀ε_{AF}+C₁rd_{AF}=0.

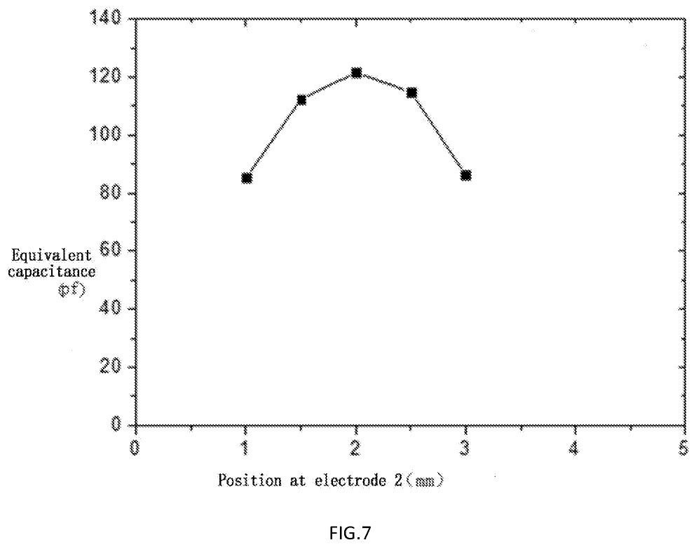

(L is the width of the electrode, r is the diameter of the droplet, d_{AF} is the thickness of the hydrophobic insulation layer, C₁ is the “chip-droplet” equivalent capacitance, and x is a position of the droplet on the electrode). In this situation, the droplet completely has a capacitance value on the electrode 1. As shown in FIG. 7, the capacitance value is highest when the droplet is at the middle position between the electrode 1 and the electrode 2. The capacitance value is the same when a volume ratio of the droplet on the electrode 1 and the electrode 2 is 1:9 or 9:1, i.e., (the droplet on the electrode is at the position of 0.4 mm and 3.6 mm. Based on the continuity of the droplets, the capacitance value between the electrode 2 and the electrode 3 can be measured in accordance with the position relationship of the equivalent capacitance value between the electrode 1 and the electrode 2 and the droplet. The specific position of the droplet is finally determined, and the main control chip STM32 regulates and controls after the data is fed back to the main control chip STM32, so that the droplet completely on the electrode 3. The relationship between the capacitance value and x (the relative position of the droplet) can be found by measuring the capacitance value thereof and analyzing the data therein. The data is as follows:

1. a group of electrodes (electrode 1 and electrode 2) are selected to measure the capacitance value between the electrodes, and the equivalent capacitance value is that: C₁=128.22 pF;

2. according to the solving formula: x²Lε₀ε_{AF}−xrLε₀ε_{AF}+C₁rd_{AF}=0, (wherein L=3*1\hat{ }−3 mm, ε₀=8.84*10\hat{ }−12, ε_{AF}=1.934, r=4*10\hat{ }−3 m, d_{AF}=400*10\hat{ }−9 m), the numerical value is that: x=2 mm;

The positions of the representative droplets on the electrode 1 and the electrode 2 are selected from the experimental data for illustration;

TABLE 1

| | Position of droplet on electrode (x)(mm) | | | | |
|---|---|---|---|---|---|
| | 1 | 1.5 | 2 | 2.5 | 3 |
| Capacitance value | 85.25 | 112.34 | 121.56 | 114.89 | 86.23 |
| (measured value) (pF) | | | | | |
| Capacitance value | 91.38 | 120.21 | 128.22 | 120.21 | 91.38 |
| (theoretical value) (pF) | | | | | |

It can be known from the above table that the capacitance value according to the established “chip-droplet” equivalent capacitance model is basically the same as that obtained by an impedance analyser.

C. Processing the Measured Capacitance Value

After each measurement of an equivalent capacitance value, the data is transmitted by the FPGA chip to a computer through a serial port for subsequent processing. Processing is used for setting up a user interface for data processing on the basis of establishing the “chip-droplet” equivalent capacitance model to clearly know the measured equivalent capacitance value and the droplet moving distance x, and thus judging the specific position and distribution of the droplet on the EWOD chip.

A droplet positioning and feedback system solution based on a system equivalent capacitance model proposed by the disclosure firstly combines a droplet driving system with a droplet positioning system, then transmits the AF real-time status to a microprocessor through the droplet inside the current chip, so that the specific position and the general distribution of the droplet on the electrode of the EWOD chip can be reflected more intuitively by data.

The preferred embodiments of the disclosure are specifically described above, but not intended to limit the innovation and creation of the disclosure. Any equivalent variations or replacements easily envisaged by those skilled in the art without departing from the spirit of the disclosure shall all fall within the protection scope of the claim of the application.

1. An electro-wetting-based microfluidic droplet positioning system, comprising
an electro-wetter,
a main control module,
a droplet drive module,
a droplet positioning module,
a power supply, and
a microprocessor connected with the main control module,
wherein, an output end of the main control module is connected with an input end of the droplet drive module, an output end of the droplet drive module is connected with an input end of the electro-wetter, an output end of the electro-wetter is connected with an input end of the droplet positioning module, an output end of the droplet positioning module is connected with an input end of the main control module, and an output end of the power supply is connected with the input end of the main control module.

2. The electro-wetting-based microfluidic droplet positioning system according to claim 1, wherein the main control module is a STM32 chip.

3. The electro-wetting-based microfluidic droplet positioning system according to claim 1, wherein the droplet drive module is a SSD1627 chip.

4. The electro-wetting-based microfluidic droplet positioning system according to claim 3, wherein the droplet drive module comprises a data collecting chip and a data processing chip.

5. The electro-wetting-based microfluidic droplet positioning system according to claim 4, wherein the data collecting chip is a Pcap01 chip.

6. The electro-wetting-based microfluidic droplet positioning system according to claim 4, wherein the data processing chip is a CycloneIV chip.

7. An electro-wetting-based microfluidic droplet positioning method, comprising the following steps of:
considering, by a system, a droplet to be measured in an electro-wetter and a hydrophobic insulation layer below the droplet as a capacitor connected in series;
issuing, by a main control chip, a command to a droplet drive module, and driving, by the droplet drive module, the droplet to be measured to move;
collecting, by a droplet positioning module, a current capacitance value of the droplet, and determining a relative position of the droplet; and
verifying, by the system, whether the droplet is at a target position;
if the droplet is not at the target position, issuing, by the main control module, a command to the droplet drive module and driving the droplet to move until the droplet reaches the target position; and
if the droplet is at the target position, issuing, by the main control module, a command to the droplet drive module and driving the droplet to move to next target position.

8. The electro-wetting-based microfluidic droplet positioning system according to claim 2, wherein the droplet drive module is a SSD1627 chip.

9. The electro-wetting-based microfluidic droplet positioning system according to claim 8, wherein the droplet drive module comprises a data collecting chip and a data processing chip.

10. The electro-wetting-based microfluidic droplet positioning system according to claim 9, wherein the data processing chip is a CycloneIV chip.
